(19) United States
(12) Patent Application Publication
(10) Pub. No.: US 2025/0021276 A1
(43) Pub. Date: Jan. 16, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Hiroto TAMURA, Kanagawa (JP)

(73) Assignee: FUJIFILM Business Innovation Corp., Tokyo (JP)

(21) Appl. No.: 18/429,473

(22) Filed: Feb. 1, 2024

(30) Foreign Application Priority Data
Jul. 11, 2023 (JP) 2023-113899

(51) Int. Cl. G06F 3/12

(52) U.S. Cl. CPC G06F 3/121; G06F 3/1234

(57) ABSTRACT

An information processing system includes one or plural processors configured to, when a change is made to setting of an information processing apparatus by a first user, identify contents of the change and contents of a job for the information processing apparatus scheduled by a second user, prior to the change, to be executed, and transmit, prior to execution of the job, a notification based on whether or not the change will impact the execution of the job.

### CROSS-REFERENCE TO RELATED APPLICATIONS

This application is based on and claims priority under 35 USC 119 from Japanese Patent Application No. 2023-113899 filed Jul. 11, 2023.

### BACKGROUND

### (i) Technical Field

The present disclosure relates to an information processing system, an information processing method, and a non-transitory computer readable medium.

### (ii) Related Art

A technique for connecting a plurality of remote terminals to an information processing apparatus, such as a so-called multifunction machine, capable of printing and reading of documents and other types of processing so that the individual remote terminals are capable of remotely operating the information processing apparatus has been known (for example, Japanese Unexamined Patent Application Publication No. 2017-216547). Such a technique enables execution of jobs and setting of schedules to execute jobs, based on remote operations performed by the plurality of remote terminals connected to the information processing apparatus.

### SUMMARY

However, during a standby period for a scheduled job, an event of preventing execution of the job may occur. Such an event is detected as error at the time of execution of the job. Thus, it is difficult for a user to recognize and handle the occurrence of the event before the time of execution of the job.

Aspects of non-limiting embodiments of the present disclosure relate to enabling a user to recognize, before the time of execution of a job for an information processing apparatus, an event of preventing the job from being executed that may occur during a standby period for the job.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or a plurality of processors configured to, when a change is made to setting of an information processing apparatus by a first user, identify contents of the change and contents of a job for the information processing apparatus scheduled by a second user, prior to the change, to be executed, and transmit, prior to execution of the job, a notification based on whether or not the change will impact the execution of the job.

### BRIEF DESCRIPTION OF THE DRAWINGS

Exemplary embodiments of the present disclosure will be described in detail based on the following figures, wherein:

FIG. 1 is a diagram illustrating an example of the entire configuration of an information processing system according to an exemplary embodiment;

FIG. 2 is a diagram illustrating an example of the hardware configuration of an image processing apparatus;

FIG. 3 is a diagram illustrating an example of the functional configuration of a controller of the image processing apparatus;

FIG. 4 is a diagram illustrating an example of the functional configuration of a controller of a user terminal;

FIG. 5 is a flowchart illustrating the flow of a process of the image processing apparatus up to the time when handling information is displayed on a user terminal of a second user;

FIG. 6 is a flowchart illustrating the flow of a process of the image processing apparatus up to the time when avoidance information is displayed;

FIG. 7 is a diagram illustrating a specific example of a process in the case where two users remotely operate a single image processing apparatus;

FIG. 8 is a diagram illustrating a specific example of a process in the case where three users remotely operate a single image processing apparatus;

FIG. 9A is a diagram illustrating a specific example of a process for determining contents of handling information in the case where the number of empty trays of the image processing apparatus is larger than the number of types of paper size necessary for executing a job;

FIG. 9B is a diagram illustrating a specific example of the process for determining contents of handling information in the case where the number of empty trays of the image processing apparatus is smaller than the number of types of paper size necessary for executing a job; and

FIG. 10 is a diagram illustrating a specific example, which is different from the specific example illustrated in FIG. 8, of the process in the case where three users remotely operate a single image processing apparatus.

### DETAILED DESCRIPTION

Hereinafter, exemplary embodiments of the present disclosure will be described in detail with reference to the attached drawings.

### <Configuration of Information Processing System>

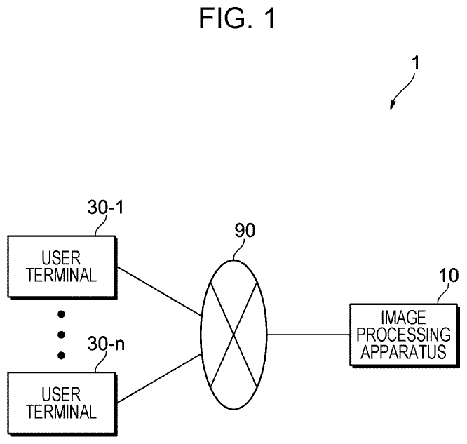

FIG. 1 is a diagram illustrating an example of the entire configuration of an information processing system 1 according to an exemplary embodiment.

The information processing system 1 is configurated in such a manner that an image processing apparatus 10 and user terminals 30-1 to 30-n (n represents an integer of 1 or more) are connected via a network 90. The network 90 is, for example, a local area network (LAN), the Internet, or the like. Hereinafter, in the case where there is no need to describe the user terminals 30-1 to 30-n separately, these user terminals will be collectively referred to as “user terminals 30”.

### (Image Processing Apparatus)

The image processing apparatus 10 is an information processing apparatus that performs various types of processing in accordance with input operations performed by a user who uses the information processing system 1. For example, the image processing apparatus 10 performs processing for forming an image on a medium such as paper, processing for outputting a recording medium on which an image is formed, processing for reading an image formed on paper or other media, and the like. The image processing apparatus 10 is, for example, a multifunction machine of a so-called electrophotographic system that forms a toner image on a printing surface of paper, a printer of a so-called inkjet system that discharges ink to a printing surface of paper, or the like.

The image processing apparatus 10 displays a user interface, receives an input operation for the user interface, and acquires input information based on the input operation. Input operations for the user interface include a direct operation and a remote operation. The direct operation is a direct input operation for the user interface displayed on the image processing apparatus 10 that is performed by a user who faces the image processing apparatus 10. The remote operation is an indirect input operation for the user interface of the image processing apparatus 10 displayed in a shared manner on a user terminal 30 that is performed by a user who operates the user terminal 30 that is remotely connected to the image processing apparatus 10.

Furthermore, the image processing apparatus 10 acquires various types of information transmitted from the user terminals 30 and performs various types of processing. The image processing apparatus 10 also transmits various types of information to the user terminals 30. For example, the image processing apparatus 10 receives a request for execution of a job as a remote operation from a user and acquires input information based on the request. A “job” represents a unit indicating predetermined processing performed by the image processing apparatus 10 (for example, printing processing for forming an image on paper, reading processing for reading an image formed on a document, or the like).

When a user (hereinafter, referred to as a “first user”) changes setting of the image processing apparatus 10, the image processing apparatus 10 identifies contents of the change in the setting and contents of a job scheduled by another user (hereinafter, referred to as a “second user”), prior to the change in the setting, to be executed. Then, the image processing apparatus 10 provides, before execution of the job scheduled by the second user to be executed, a notification based on whether or not there will be an impact on execution of the scheduled job.

A “change in setting” is, for example, a change in the type of paper loaded in a tray of the image processing apparatus 10. Furthermore, a “notification based on whether or not there will be an impact on execution of the scheduled job” represents displaying on the user terminal 30 of the second user information about the impact of a change in setting made by the first user on execution of the job scheduled by the second user to be executed. In this case, for example, information indicating that a change in setting made by the first user will impact the execution of the job scheduled by the second user to be executed, information indicating that a change in setting made by the first user will not impact the execution of the job scheduled by the second user to be executed, or the like is displayed on the user terminal 30 of the second user.

In the case where a change in setting made by the first user impacts the execution of the job scheduled by the second user to be executed and the impact of the change may prevent the execution of the job, the image processing apparatus 10 displays on the user terminal 30 of the second user information for removing the impact (hereinafter, referred to as “handling information”). The handling information is, for example, help information for helping setting of paper to be set in a tray of the image processing apparatus 10.

Handling information displayed on the user terminal 30 of the second user is information for removing the impact of a change in setting made by the first user on execution of a job scheduled by the second user to be executed. Contents of the handling information may take into consideration an impact on a subsequent job scheduled by another user (hereinafter, referred to as a “third user”) who is different from the first user and the second user to be executed. For example, handling information that takes into consideration whether or not execution of the subsequent job scheduled by the third user to be executed will be prevented may be displayed on the user terminal 30 of the second user.

Furthermore, the image processing apparatus 10 displays, as the “notification based on whether or not there will be an impact on execution of the scheduled job,” information about the impact of a change in setting made by the first user on execution of the job scheduled by the second user to be executed, on the image processing apparatus 10. In this case, for example, information indicating that the change in the setting made by the first user will impact the execution of the job scheduled by the second user to be executed, information indicating that the change in the setting made by the first user will not impact the execution of the job scheduled by the second user to be executed, or the like is displayed on the image processing apparatus 10.

In the case where a change in setting made by the first user will impact the execution of the job scheduled by the second user to be executed and the impact may prevent the execution of the job, the image processing apparatus 10 displays information for avoiding the impact (hereinafter, referred to as “avoidance information”) on the image processing apparatus 10 or displays the information on the user terminal 30. The details of a configuration and a process of the image processing apparatus 10 will be described later.

### (User Terminals)

Each of the user terminals 30 is an information processing apparatus, such as a smartphone, a tablet terminal, or a personal computer, operated by a user who uses the information processing system 1. Application software allowing the user terminal 30 to remotely operate the image processing apparatus 10 is installed in the user terminal 30.

The user terminal 30 acquires various types of information transmitted from the image processing apparatus 10 and performs various types of processing. The user terminal 30 also transmits various types of information to the image processing apparatus. For example, the user terminal 30 displays in a shared manner a user interface of the image processing apparatus 10 that is remotely connected to the user terminal 30. Furthermore, the user terminal 30 receives an input operation for the user interface that is displayed in a shared manner and acquires input information based on the input operation.

For example, when an input operation for causing the image processing apparatus 10 to execute a job, as an input operation for the user interface that is displayed in a shared manner, is performed, the user terminal 30 receives the input operation as an execution schedule of the job and acquires input information based on the input operation. Then, the user terminal 30 transmits the acquired input information regarding the execution schedule of the job to the image processing apparatus 10.

Furthermore, when information about the impact of a change in setting made by the first user on the execution of the job scheduled by the second user to be executed, as a notification based on whether or not there will be an impact on the execution of the scheduled job, is transmitted to the user terminal 30 of the second user, the user terminal 30 of the second user displays the transmitted information. Details of a configuration and a process of the user terminal 30 will be described later.

The configuration of the information processing system 1 described above is merely an example. The information processing system 1 in its entirety needs to have functions for executing the processing described above. Thus, part of or all the functions for executing the processing described above may be shared or cooperated in the information processing system 1. That is, part of or all the functions of a user terminal 30 may be provided in the image processing apparatus 10 or part of or all the functions of the image processing apparatus 10 may be provided in the user terminal 30. Furthermore, part of or all the functions of the user terminal 30 and the image processing apparatus 10 that configurate the information processing system 1 may be transferred to other servers not illustrated in drawings. Thus, processing as the entire information processing system 1 may be promoted and a plurality of types of processing may complement each other.

### <Hardware Configuration of Image Processing Apparatus>

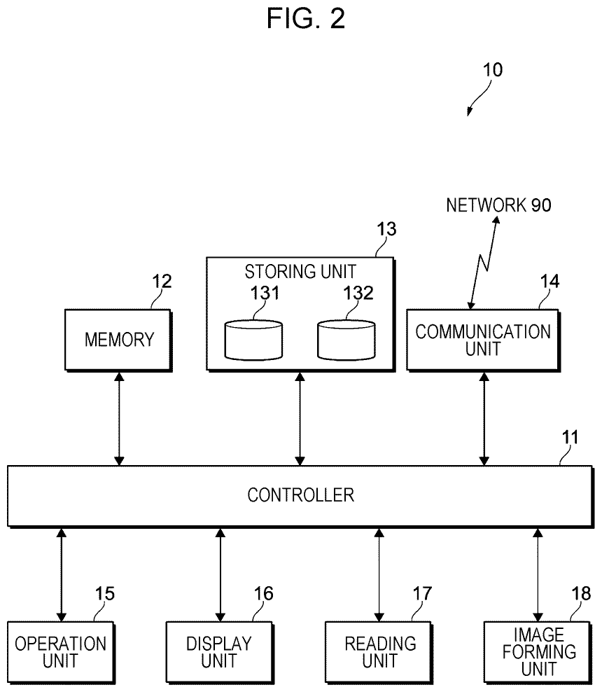

FIG. 2 is a diagram illustrating an example of the hardware configuration of the image processing apparatus 10.

The image processing apparatus 10 includes a controller 11, a memory 12, a storing unit 13, a communication unit 14, an operation unit 15, a display unit 16, a reading unit 17, and an image forming unit 18. These units are connected by a data bus, an address bus, a peripheral component interconnect (PCI) bus, or the like.

The controller 11 is a processor that controls functions of the image processing apparatus 10 through execution of various types of software such as operating software (OS) and application software. The controller 11 includes, for example, a central processing unit (CPU). The memory 12 is a storage region in which various types of software and data used for execution of the various types of software are stored and is used as a work area for calculation. The memory 12 includes, for example, a random access memory (RAM).

The storing unit 13 is a storage region in which data to be input to various types of software, data output from various types of software, and the like are stored. The storing unit 13 includes, for example, a hard disk drive (HDD), a solid state drive (SSD), a semiconductor memory, or the like used for storing programs and various types of setting data. For example, as databases in which various types of information are stored, an apparatus DB 131 in which information about the state of setting of the image processing apparatus 10 (hereinafter, referred to as “apparatus information”) is stored, a job DB 132 in which information about a scheduled job (hereinafter, referred to as “job information”) is stored, and the like are provided in the storing unit 13.

The communication unit 14 performs transmission and reception of data to and from the user terminals 30 and other devices via the network 90. The operation unit 15 includes, for example, a software keyboard, mechanical buttons, switches, and the like and receives input operations. The operation unit 15 also includes a touch sensor that forms a touch panel to be integrated with the display unit 16. The display unit 16 includes, for example, a liquid crystal display or an organic electroluminescence (EL) display used for displaying information and displays data of images, text, and the like.

The reading unit 17 reads an image recorded on a medium such as paper as a recording medium (for example, a document of a paper medium). The reading unit 17 includes, for example, a scanner of a charge coupled devices (CCD) type that reduces, with a lens, reflected light with respect to light radiated from a light source to a document and receives, with CCD, the light, a scanner of a contact image sensor (CIS) type that receives, with a CIS, reflected light with respect to light sequentially radiated from a light-emitting diode (LED) light source to a document, or the like. The image forming unit 18 forms, for example, using an electrophotographic system or an inkjet system, an image as a printing target on a printing surface of paper as a recording medium. The units described above are connected by a data bus, an address bus, a PCI bus, or the like.

### <Hardware Configuration of User Terminals>

The hardware configuration of each of the user terminals 30 is similar to the hardware configuration of the image processing apparatus 10 illustrated in FIG. 2 with the exception of the reading unit 17 and the image forming unit 18. That is, the user terminal 30 includes a controller, a memory, a storing unit, a communication unit, an operation unit, and a display unit that have functions similar to functions of the controller 11, the memory 12, the storing unit 13, the communication unit 14, the operation unit 15, and the display unit 16 in FIG. 2, and illustration in drawings and description of these units are omitted.

### <Functional Configuration of Controller of Image Processing Apparatus>

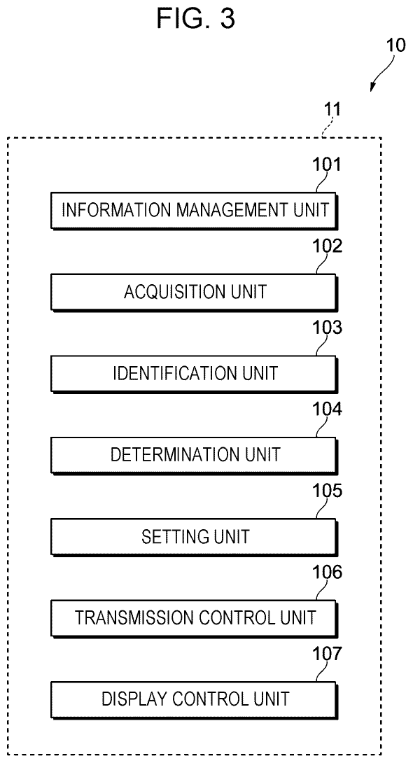

FIG. 3 is a diagram illustrating an example of the functional configuration of the controller 11 of the image processing apparatus 10.

In the controller 11 of the image processing apparatus 10, an information management unit 101, an acquisition unit 102, an identification unit 103, a determination unit 104, a setting unit 105, a transmission control unit 106, and a display control unit 107 function.

The information management unit 101 stores various types of information into databases of the storing unit 13 (see FIG. 2) and manages the various types of information. For example, the information management unit 101 stores apparatus information into the apparatus DB 131 and manages the apparatus information. The apparatus information managed by the information management unit 101 contains identification information (for example, an apparatus ID) capable of uniquely identifying the image processing apparatus 10, information indicating types of paper loaded in trays, and the like. Furthermore, job information managed by the information management unit 101 contains identification information (for example, a job ID) capable of uniquely identifying a job, information indicating whether or not a job is scheduled to be executed, processing details, and the like.

The acquisition unit 102 acquires various types of information. For example, the acquisition unit 102 acquires various types of information transmitted from the user terminals 30. Information transmitted from the user terminals 30 is, for example, input information regarding an execution schedule of a job.

When the first user changes setting of the image processing apparatus 10, the identification unit 103 identifies contents of the change in the setting and contents of a job scheduled by the second user, prior to the change in the setting, to be executed.

The determination unit 104 determines whether or not a change has been made to setting of the image processing apparatus 10. In the case where a change has been made to setting of the image processing apparatus 10, the determination unit 104 determines whether or not the change in the setting will impact the execution of the job scheduled by the second user to be executed.

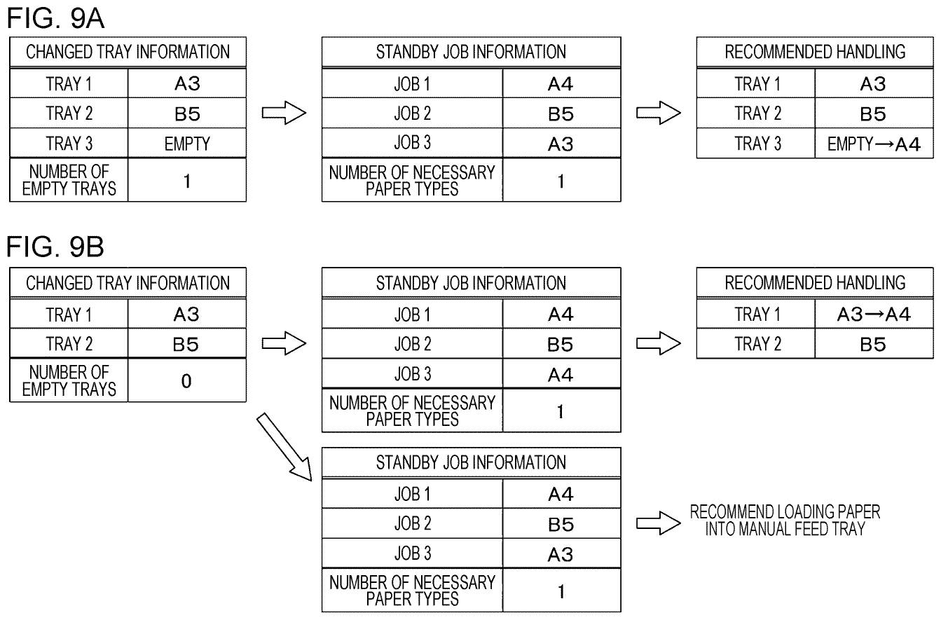

The setting unit 105 sets contents of handling information displayed on the user terminals 30. For example, the setting unit 105 sets contents of handling information displayed on the user terminal 30 in such a manner that the change in the setting made by the first user will not prevent the execution of the job scheduled by the second user to be executed. Furthermore, the setting unit 105 sets contents of handling information displayed on the user terminal 30 in such a manner that execution of a subsequent job scheduled by the third user to be executed will not be prevented. A specific example of a method for setting contents of handling information will be described later with reference to FIGS. 9A and 9B.

The transmission control unit 106 performs control for transmitting various types of information through the communication unit 14 (see FIG. 2). For example, the transmission control unit 106 performs control for transmitting various types of information to the user terminals 30. Information transmitted to a user terminal 30 is, for example, control information for displaying various types of information on the display unit of the user terminal 30.

The control information transmitted to the user terminal 30 is, for example, control information for displaying in a shared manner on the display unit of the user terminal 30 a user interface displayed on the display unit 16 of the image processing apparatus 10, control information for displaying on the display unit of the user terminal 30 information about the impact of a change in setting made by the first user on the execution of a job scheduled by the second user to be executed, control information for displaying handling information on the display unit of the user terminal 30, or the like.

The display control unit 107 performs control for displaying various types of information on the display unit 16 (see FIG. 2). For example, the display control unit 107 performs control for displaying a user interface on the display unit 16. The display control unit 107 also performs control for displaying avoidance information on the display unit 16.

Furthermore, the display control unit 107 performs control for displaying various types of information on the display unit of the user terminal 30. For example, the display control unit 107 performs control for displaying in a shared manner on the display unit of the user terminal 30 a user interface displayed on the display unit 16. Furthermore, the display control unit 107 performs control for displaying on the display unit of the user terminal 30 information about the impact of a change in setting made by the first user on the execution of a job scheduled by the second user to be executed. The display control unit 107 also performs control for displaying handling information on the display unit of the user terminal 30.

### (Functional Configuration of Controller of User Terminals)

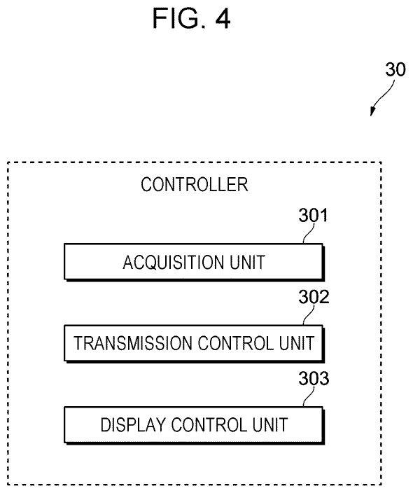

FIG. 4 is a diagram illustrating an example of the functional configuration of the controller of each of the user terminals 30.

In the controller of the user terminal 30, an acquisition unit 301, a transmission control unit 302, and a display control unit 303 function.

The acquisition unit 301 acquires various types of information. For example, the acquisition unit 301 acquires input information received by the operation unit of the user terminal 30. Furthermore, for example, the acquisition unit 301 acquires various type of information transmitted from the image processing apparatus 10. The information transmitted from the image processing apparatus 10 is, for example, control information for displaying various types of information on the display unit of the user terminal 30.

The transmission control unit 302 performs control for transmitting various types of information via the communication unit. For example, the transmission control unit 302 performs control for transmitting various types of information to the image processing apparatus 10. The information transmitted to the image processing apparatus 10 is, for example, input information acquired by the acquisition unit 301. The input information acquired by the acquisition unit 301 and transmitted to the image processing apparatus 10 is, for example, input information regarding an execution schedule of a job.

The display control unit 303 performs control for displaying various types of information on the display unit. For example, the display control unit 303 performs control for displaying in a shared manner on the display unit of the user terminal 30 a user interface displayed on the display unit 16 of the image processing apparatus 10 (see FIG. 2). Furthermore, the display control unit 303 performs control for displaying on the display unit information about the impact of a change in setting made by the first user on the execution of a job scheduled by the second user to be executed. Furthermore, the display control unit 303 performs control for displaying handling information on the display unit. Specifically, the display control unit 303 displays on the display unit the information mentioned above, based on the control information acquired by the acquisition unit 301.

### <Flow of Process>

### (Flow of Process of Image Processing Apparatus)

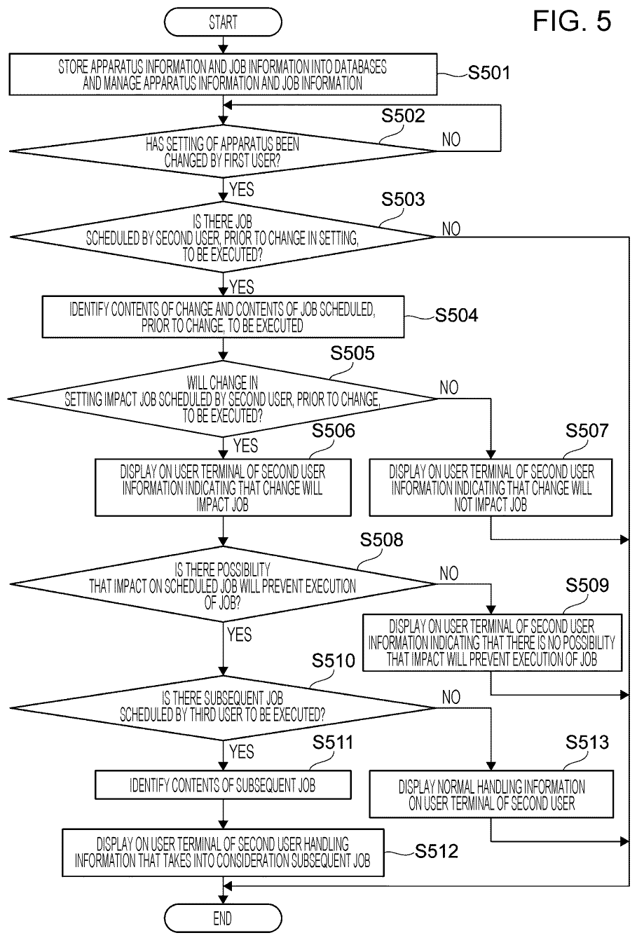

FIG. 5 is a flowchart illustrating the flow of a process of the image processing apparatus 10 up to display of handling information on the user terminal 30 of the second user.

The image processing apparatus 10 stores apparatus information and job information into databases and manages the apparatus information and the job information (step 501). Specifically, the image processing apparatus 10 stores apparatus information into the apparatus DB 131 of the storing unit 13 (see FIG. 2) and stores job information into the job DB 132 and manages the job information.

When a change is made to setting of the image processing apparatus 10 by the first user (YES in step 502), the image processing apparatus 10 proceeds to determination processing of step 503. In contrast, in the case where no change is made to setting of the image processing apparatus 10 by the first user (NO in step 502), the image processing apparatus 10 repeats the determination processing of step 502.

In the case where there is a job scheduled by the second user, prior to the change in the setting, to be executed (YES in step 503), the image processing apparatus 10 identifies contents of the change and contents of the job scheduled, prior to the change, to be executed (step 504) and proceeds to determination processing of step 505. In contrast, in the case where there is no job scheduled by the second user, prior to the change in the setting, to be executed (NO in step 503), the image processing apparatus 10 ends the process (END).

In the case where the change in the setting of the image processing apparatus 10 made by the first user will impact the job scheduled by the second user, prior to the change, to be executed (YES in step 505), the image processing apparatus 10 displays on the user terminal 30 of the second user information indicating that the change will impact the job (step 506) and proceeds to determination processing of step 508. In contrast, in the case where the change in the setting of the image processing apparatus 10 made by the first user will not impact the job scheduled by the second user, prior to the change, to be executed (NO in step 505), the image processing apparatus 10 displays on the user terminal 30 of the second user information indicating that the change will not impact the job (step 507) and ends the process (END).

In the case where there is a possibility that the impact on the job scheduled by the second user, prior to the change in the setting, to be executed will prevent the execution of the job (YES in step 508), the image processing apparatus 10 proceeds to determination processing of step 510. In contrast, in the case where there is no possibility that the impact on the job scheduled by the second user, prior to the change in the setting, to be executed will prevent the execution of the job (NO in step 508), the image processing apparatus 10 displays on the user terminal 30 of the second user information indicating that there is no possibility that the impact will prevent the execution of the job (step 509) and ends the process (END).

In the case where there is a subsequent job scheduled by the third user to be executed (YES in step 510), the image processing apparatus 10 identifies contents of the subsequent job (step 511), displays on the user terminal 30 of the second user handling information that takes into consideration the subsequent job (step 512), and ends the process (END). In contrast, in the case where there is no subsequent job scheduled by the third user to be executed (NO in step 510), the image processing apparatus 10 displays on the user terminal 30 of the second user normal handling information that does not take into consideration a subsequent job (step 513) and ends the process (END).

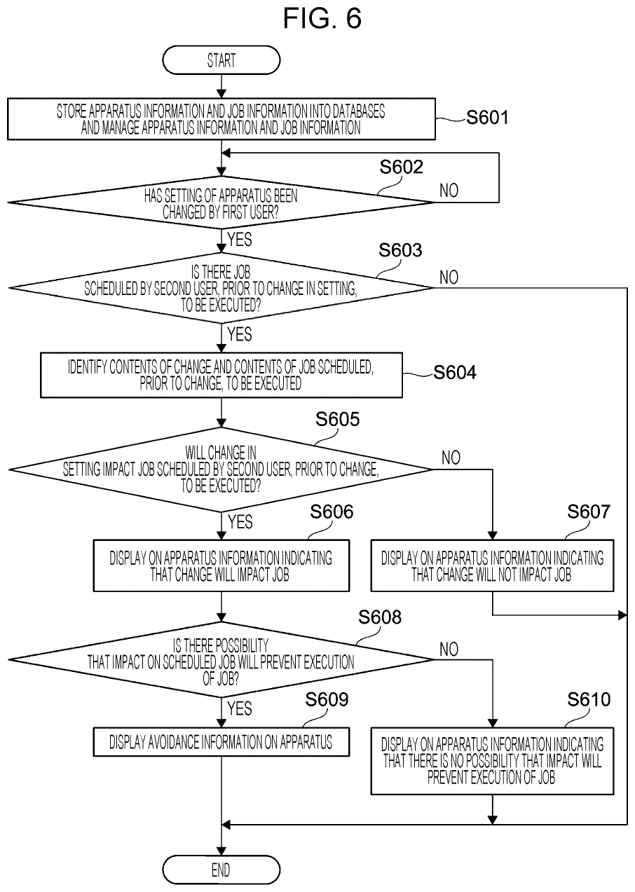

FIG. 6 is a flowchart illustrating the flow of a process of the image processing apparatus 10 up to display of avoidance information.

The flow of the process of the image processing apparatus 10 illustrated in the example of FIG. 6 from steps 601 to 604 is similar to the flow of the process of the image processing apparatus 10 illustrated in the example of FIG. 5 from steps 501 to 504, and description of steps 601 to 604 will be omitted.

In the case where the change in the setting of the image processing apparatus 10 made by the first user will impact the execution of the job scheduled by the second user, prior to the change, to be executed (YES in step 605), the image processing apparatus 10 displays on the image processing apparatus 10 information indicating that the change will impact the execution of the job (step 606) and proceeds to determination processing of step 608. In contrast, in the case where the change in the setting of the image processing apparatus 10 made by the first user will not impact the execution of the job scheduled by the second user, prior to the change, to be executed (NO in step 605), the image processing apparatus 10 displays on the image processing apparatus 10 information indicating that the change will not impact the execution of the job (step 607) and ends the process (END).

In the case where there is a possibility that the impact on the job scheduled by the second user, prior to the change in the setting, to be executed will prevent the execution of the job (YES in step 608), the image processing apparatus 10 displays avoidance information on the image processing apparatus 10 (step 609) and ends the process (END). In contrast, in the case where there is no possibility that the impact on the job scheduled by the second user, prior to the change in the setting, to be executed will prevent the execution of the job (NO in step 608), the image processing apparatus 10 displays on the image processing apparatus 10 information indicating that there is no possibility that the impact will prevent the execution of the change (step 610) and ends the process (END).

### Specific Examples

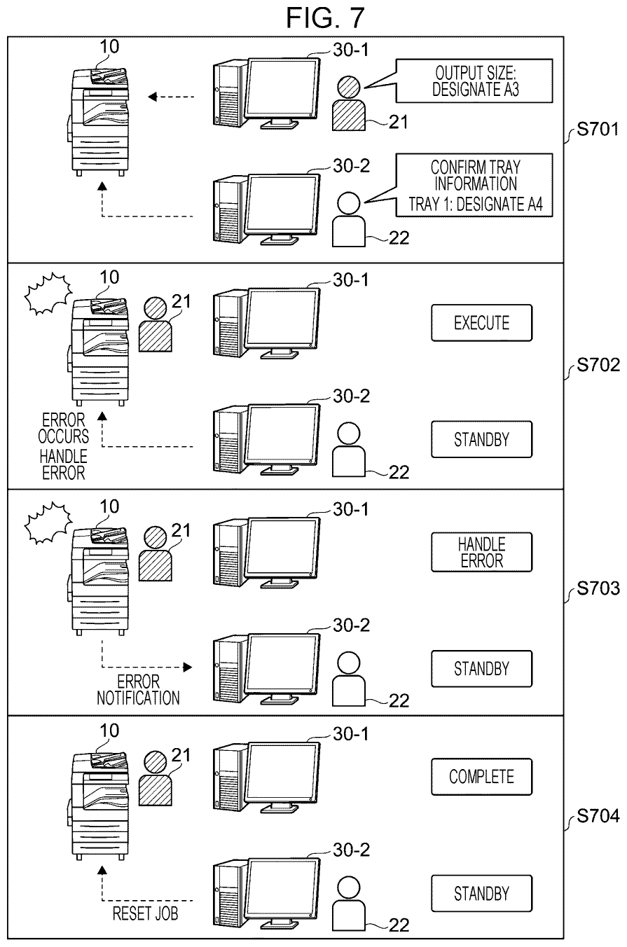

FIG. 7 is a diagram illustrating a specific example of a process in the case where two users remotely operate a single image processing apparatus 10.

In the example illustrated in FIG. 7, a first user 21 uses the user terminal 30-1 to remotely operate the image processing apparatus 10, and a second user 22 uses the user terminal 30-2 to remotely operate the image processing apparatus 10. Furthermore, only a “tray 1” is mounted on the image processing apparatus 10, and time flows from the top to the bottom in FIG. 7.

First, as a request for a print job from the first user 21, “Output size: A3” is designated. Next, as an execution schedule of a print job set by the second user 22 who has confirmed information about paper loaded in a tray of the image processing apparatus 10 (hereinafter, referred to as “tray information”), “tray 1: A4” is designated (step 701).

In this case, A4 size paper is loaded in the tray 1 of the image processing apparatus 10, and A3 size paper designated by the first user 21 is not loaded. Therefore, error occurs when the first user 21 tries to execute the print job. Thus, the first user 21 changes setting by replacing A4 size paper loaded in the tray 1 of the image processing apparatus 10 with A3 size paper, as handling of error, and executes the job. At this time, the job scheduled by the second user 22 to be executed enters a standby state because the job for the first user 21 is being executed (step 702).

The image processing apparatus 10 confirms whether or not there is a standby job that is impacted at the time when handling of error is performed by the first user 21. In the case where the job scheduled by the second user 22 to be executed will be impacted, the image processing apparatus 10 transmits an error notification indicating that the job scheduled by the second user 22 to be executed will be impacted to the user terminal 30-2 (step 703).

The second user 22 who has received the error notification performs resetting of the scheduled job (for example, setting for designating “tray 1: A3”) or arranges to load A4 size paper into the tray 1, as handling of the error (step 704).

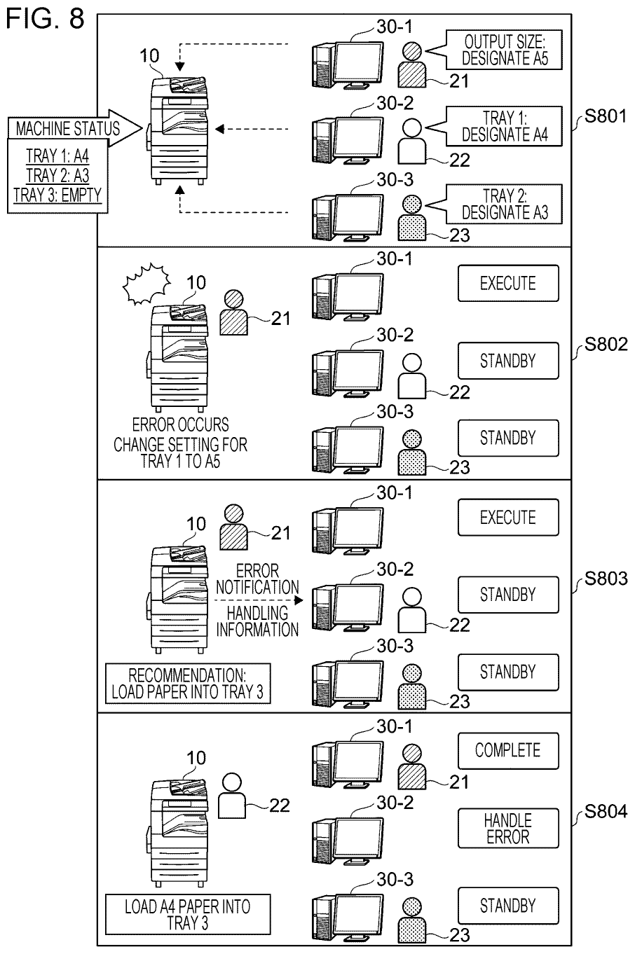

FIG. 8 is a diagram illustrating a specific example of a process in the case where three users remotely operate a single image processing apparatus 10.

In the example illustrated in FIG. 8, the first user 21 uses the user terminal 30-1 to remotely operate the image processing apparatus 10, the second user 22 uses the user terminal 30-2 to remotely operate the image processing apparatus 10, and a third user 23 uses the user terminal 30-3 to remotely operate the image processing apparatus 10. Furthermore, as indicated as “machine status”, a “tray 1”, a “tray 2”, and a “tray 3” are mounted on the image processing apparatus 10. A4 size paper is loaded in the “tray 1”, A3 size paper is loaded in the “tray 2”, and no paper is loaded in the “tray 3”, that is, the “tray 3” is an “empty tray”. Furthermore, time flows from the top to the bottom in FIG. 8.

First, as a request for a print job from the first user 21, “output size: A5” is designated. Next, as an execution schedule of a print job set by the second user 22, “tray 1: A4” is designated. Then, as an execution schedule of a print job set by the third user 23, “tray 2: A3” is designated (step 801).

In this case, A5 size paper, which is designated by the first user 21, is not loaded in any of the trays. Therefore, error occurs when the first user 21 tries to execute the print job. Thus, the first user 21 changes setting by replacing A4 size paper, which is loaded in the tray 1 of the image processing apparatus 10, with A5 size paper, as handling of the error, and executes the job. At this time, the job scheduled by the second user 22 to be executed and the job scheduled by the third user 23 to be executed enter a standby state because the job for the first user 21 is being executed (step 802).

The image processing apparatus 10 confirms whether or not there is a standby job that is impacted at the time when handling of the error is performed by the first user 21. In the case where the job scheduled by the second user 22 to be executed will be impacted, the image processing apparatus 10 transmits an error notification indicating that the job scheduled by the second user 22 to be executed will be impacted and handling information that does not impact the job scheduled by the third user 23 to be executed to the user terminal 30-2. In this case, as the handling information, loading A4 size paper into the tray 3, which is the empty tray, is recommended (step 803).

The second user 22 who has received the error notification and the handling information loads A4 size paper into the tray 3 as handling of the error. In this case, since A3 size paper is still loaded in the tray 2, the job scheduled by the third user 23 to be executed is not impacted (step 804).

FIGS. 9A and 9B are diagrams illustrating specific examples of a process for determining contents of handling information. FIG. 9A is a diagram illustrating a specific example of the process in the case where the number of empty trays of the image processing apparatus 10 is larger than the number of types of paper size necessary for executing a job. FIG. 9B is a diagram illustrating a specific example of the process in the case where the number of empty trays of the image processing apparatus 10 is smaller than the number of types of paper size necessary for executing a job.

The image processing apparatus 10 sets contents of handling information by confirming tray information in which setting has been changed and information about the size of paper designated for each scheduled standby job (hereinafter, referred to as “standby job information”) and identifying the type of paper size necessary for executing the job. The standby job information represents information contained in job information stored in the job DB 132.

For example, in the case where the number of empty trays of the image processing apparatus 10 is larger than the number of types of paper size necessary for executing a job, loading paper into an empty tray is recommended as handling information. Specifically, as illustrated in FIG. 9A, it is assumed that contents of changed tray information about the image processing apparatus 10 on which the trays 1, 2, and 3 are mounted indicate that A3 size paper and B5 size paper are loaded in the tray 1 and the tray 2, respectively, the tray 3 is an empty tray, and the “number of empty trays” is “1” (tray 3).

Furthermore, it is assumed that standby job information indicates that the paper sizes designated in the jobs 1, 2, and 3 are A4, B5, and A3, respectively, and the number of types of paper size necessary for executing a job (number of necessary paper types) is “1” (A4 size). In this case, the image processing apparatus 10 recommends that, as handling information (recommended handling), A4 size paper be loaded into the tray 3, which is an empty tray.

Furthermore, for example, in the case where the number of empty trays of the image processing apparatus 10 is smaller than the number of types of paper size necessary for executing a job, as handling information, it is recommended to replace unnecessary paper with necessary paper or to load necessary paper to a manual feed tray. Specifically, for example, as illustrated in FIG. 9B, it is assumed that contents of changed tray information about the image processing apparatus 10 on which the trays 1 and 2 are mounted indicate that A3 size paper and B5 size paper are loaded in the tray 1 and the tray 2, respectively, and the “number of empty trays” is “0”.

Furthermore, it is assumed that standby job information indicates that the paper sizes designated in the jobs 1, 2, and 3 are A4, B5, and A4, respectively, and the number of types of paper size necessary for executing a job (number of necessary paper types) is “1” (A4 size). In this case, the image processing apparatus 10 recommends that unnecessary paper be replaced with necessary paper as handling information (recommended handling). Specifically, the image processing apparatus 10 recommends that A3 size paper loaded in the tray 1 be replaced with A4 size paper. That is, in the case where an unnecessary type of paper size is loaded in a tray, it is recommended that unnecessary paper be replaced with necessary paper as handling information.

Furthermore, it is assumed that standby job information indicates that the paper sizes designated in the jobs 1, 2, and 3 are A4, B5, and A3, respectively, and the number of types of paper size necessary for executing a job (number of necessary paper types) is “1” (A4 size). In this case, the image processing apparatus 10 recommends that A4 size paper be loaded into a manual feed tray as handling information. That is, in the case where unnecessary paper is not loaded in any tray, it is recommended that paper be loaded into a manual feed tray.

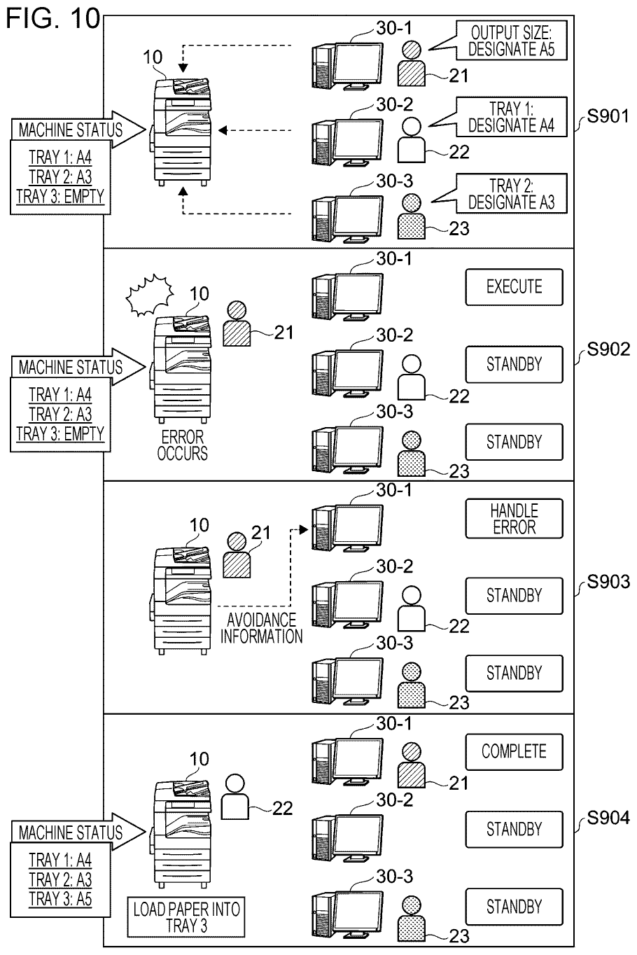

FIG. 10 is a diagram illustrating a specific example, which is different from the specific example illustrated in FIG. 8, of the process in the case where three users remotely operate a single image processing apparatus 10.

In the example illustrated in FIG. 10, it is assumed that the first user 21 uses the user terminal 30-1 to remotely operate the image processing apparatus 10, the second user 22 uses the user terminal 30-2 to remotely operate the image processing apparatus 10, and the third user 23 uses the user terminal 30-3 to remotely operate the image processing apparatus 10. Furthermore, as indicated as “machine status”, the “tray 1”, the “tray 2”, and the “tray 3” are mounted on the image processing apparatus 10, A4 size paper is loaded in the “tray 1”, A3 size paper is loaded in the “tray 2”, and no paper is loaded in the “tray 3”, that is, the “tray 3” is an “empty tray”. Furthermore, time flows from the top to the bottom in FIG. 10.

First, as a request for a print job from the first user 21, “output size: A5” is designated. Next, as an execution schedule of a print job set by the second user 22, “tray 1: A4” is designated. Then, as an execution schedule of a print job set by the third user 23, “tray 2: A3” is designated (step 901).

In this case, A5 size paper, which is designated by the first user 21, is not loaded in any of the trays. Therefore, error occurs when the first user 21 tries to execute the print job. At this time, the job scheduled by the second user 22 to be executed and the job scheduled by the third user 23 to be executed enter a standby state because the job for the first user 21 is being executed (step 902).

In the case where there is a concern that handling of the error performed by the first user 21 may impact a standby job, the image processing apparatus 10 displays on the user terminal 30-1 or on the image processing apparatus 10 avoidance information for avoiding the impact of the handling of the error as well as an error notification. In this case, as avoidance information, it is recommended that A5 size paper be loaded into the tray 3, which is in the empty tray state (step 903).

The first user 21 references the avoidance information and executes the job by, as handling of the error, loading A5 size paper into the tray 3, which is in the empty tray state. In this case, since A4 size paper and A3 size paper are still loaded in the tray 1 and the tray 2, respectively, neither the job scheduled by the second user 22 to be executed nor the job scheduled by the third user 23 to be executed will be impacted (step 904).

### Other Exemplary Embodiments

The exemplary embodiment has been described above. However, the present disclosure is not limited to the exemplary embodiment described above. Furthermore, effects achieved by the present disclosure are not limited to those described in the foregoing exemplary embodiment. For example, the configuration of the information processing system 1 illustrated in FIG. 1 and the hardware configuration of the image processing apparatus 10 illustrated in FIG. 2 are merely examples provided to attain advantages of the present disclosure and are not particularly limited. Furthermore, the functional configuration of the image processing apparatus 10 illustrated in FIG. 3 and the functional configuration of each of the user terminals 30 illustrated in FIG. 4 are merely examples and are not particularly limited. As long as the information processing system 1 in FIG. 1 is provided with functions capable of executing the processing described above in its entirety, a functional configuration to be used to implement the functions is not limited to the examples in FIGS. 3 and 4.

Furthermore, orders of steps in the processes of the image processing apparatus 10 illustrated in FIGS. 5 and 6 are merely examples and are not particularly limited. Processing steps are not necessarily performed in the illustrated orders of steps in a chronological manner and may be performed concurrently or individually. Furthermore, the specific examples illustrated in FIGS. 7 to 10 are merely examples and are not particularly limited.

For example, in the specific examples illustrated in FIGS. 7 to 10, examples in which the number of users is two or three are illustrated. However, the number of users is not particularly limited as long as there are a plurality of users, and the number of users may be four or more. In this case, as in the examples described above, an error notification, handling information, and avoidance information are displayed on the user terminal 30 of each of the target users.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or a plurality of processors configured to:
   when a change is made to setting of an information processing apparatus by a first user, identify contents of the change and contents of a job for the information processing apparatus scheduled by a second user, prior to the change, to be executed; and
   transmit, prior to execution of the job, a notification based on whether or not the change will impact the execution of the job.
      (((2)))

The information processing system according to (((1))), wherein the one or the plurality of processors are configured to:
identify the contents of the change and contents of a job for the information processing apparatus scheduled, based on a remote operation performed by a remote terminal of the second user, to be executed; and
display information about the impact of the change on the execution of the job, as the notification, on the remote terminal of the second user.
   (((3)))

The information processing system according to (((2))), wherein the one or the plurality of processors are configured to, in a case where there is a possibility that the impact will prevent the execution of the job, further display handling information for removing the impact, as the notification, on the remote terminal of the second user.

(((4)))

The information processing system according to (((3))), wherein the one or the plurality of processors are configured to:
further identify contents of a subsequent job scheduled, based on a remote operation performed by a remote terminal of a third user, to be executed; and
set contents of the handling information based on whether or not removal of the impact based on the handling information displayed on the remote terminal of the second user will impact execution of the subsequent job.
   (((5)))

The information processing system according to (((4))), wherein the one or the plurality of processors are configured to, in a case where there is a possibility that the removal of the impact based on the handling information will prevent the execution of the subsequent job, display on the remote terminal of the second user the handling information that takes into consideration the impact on the execution of the subsequent job.

(((6)))

The information processing system according to any one of (((3))) to (((5))), wherein the one or the plurality of processors are configured to display information about the impact of the change on the execution of the job, as the notification, on the information processing apparatus.

(((7)))

The information processing system according to (((6))), wherein the one or the plurality of processors are configured to, in a case where there is a possibility that the impact will prevent the execution of the job, display avoidance information for avoiding the impact, as the information about the impact of the change on the execution of the job, on the information processing apparatus.

(((8)))

The information processing system according to any one of (((3))) to (((7))), wherein the information processing apparatus is an image processing apparatus, the setting is setting of a type of paper set in each of one or more trays of the image processing apparatus, the job is printing processing for forming an image on the paper, and the handling information is help information for helping setting of the paper to be set in each of the one or more trays.

(((9)))

A program for causing a computer to execute:
a function for, when a change is made to setting of an information processing apparatus by a first user, identifying contents of the change and contents of a job for the information processing apparatus scheduled by a second user, prior to the change, to be executed; and
a function for transmitting, prior to execution of the job, a notification based on whether or not the change will impact the execution of the job.

What is claimed is:

1. An information processing system comprising:
one or a plurality of processors configured to:
when a change is made to setting of an information processing apparatus by a first user, identify contents of the change and contents of a job for the information processing apparatus scheduled by a second user, prior to the change, to be executed; and
transmit, prior to execution of the job, a notification based on whether or not the change will impact the execution of the job.

2. The information processing system according to claim 1, wherein the one or the plurality of processors are configured to:
identify the contents of the change and contents of a job for the information processing apparatus scheduled, based on a remote operation performed by a remote terminal of the second user, to be executed; and
display information about the impact of the change on the execution of the job, as the notification, on the remote terminal of the second user.

3. The information processing system according to claim 2, wherein the one or the plurality of processors are configured to, in a case where there is a possibility that the impact will prevent the execution of the job, further display handling information for removing the impact, as the notification, on the remote terminal of the second user.

4. The information processing system according to claim 3, wherein the one or the plurality of processors are configured to:
further identify contents of a subsequent job scheduled, based on a remote operation performed by a remote terminal of a third user, to be executed; and
set contents of the handling information based on whether or not removal of the impact based on the handling information displayed on the remote terminal of the second user will impact execution of the subsequent job.

5. The information processing system according to claim 4, wherein the one or the plurality of processors are configured to, in a case where there is a possibility that the removal of the impact based on the handling information will prevent the execution of the subsequent job, display on the remote terminal of the second user the handling information that takes into consideration the impact on the execution of the subsequent job.

6. The information processing system according to claim 2, wherein the one or the plurality of processors are configured to display information about the impact of the change on the execution of the job, as the notification, on the information processing apparatus.

7. The information processing system according to claim 6, wherein the one or the plurality of processors are configured to, in a case where there is a possibility that the impact will prevent the execution of the job, display avoidance information for avoiding the impact, as the information about the impact of the change on the execution of the job, on the information processing apparatus.

8. The information processing system according to claim 3, wherein the information processing apparatus is an image processing apparatus, the setting is setting of a type of paper set in each of one or more trays of the image processing apparatus, the job is printing processing for forming an image on the paper, and the handling information is help information for helping setting of the paper to be set in each of the one or more trays.

9. An information processing method comprising:
when a change is made to setting of an information processing apparatus by a first user, identifying contents of the change and contents of a job for the information processing apparatus scheduled by a second user, prior to the change, to be executed; and
transmitting, prior to execution of the job, a notification based on whether or not the change will impact the execution of the job.

10. A non-transitory computer readable medium storing a program causing a computer to execute a process comprising:
when a change is made to setting of an information processing apparatus by a first user, identifying contents of the change and contents of a job for the information processing apparatus scheduled by a second user, prior to the change, to be executed; and
transmitting, prior to execution of the job, a notification based on whether or not the change will impact the execution of the job.
